(19) United States
(12) Patent Application Publication
(10) Pub. No.: US 2004/0054544 A1
(43) Pub. Date: Mar. 18, 2004

(54) Fundraising system and method

(76) Inventor: Alexander Sloot, Sugarloaf, PA (US)

Correspondence Address: ST. ONGE STEWARD JOHNSTON & REENS, LLC, 986 BEDFORD STREET, STAMFORD, CT, 06905-5619, US

(21) Appl. No.: 10/242,230

(22) Filed: Sep. 12, 2002

(51) Int. Cl. G06F 17/60

(52) U.S. Cl. 705/1

(57) ABSTRACT

A fundraising method and a kit for use with such a method are provided. The method involves providing volunteers with a fundraising kit having a predetermined capacity for holding coins, and allowing time for the volunteers to collect coins and to at least partially fill the fundraising kits with collected coins. Completed fundraising kits are collected from the volunteers and each volunteer is entered in a prize drawing for each completed kit collected from that volunteer. All outstanding fundraising kits, whether or not completed, are collected from the volunteers at the end of a predetermined time period and, again, each volunteer may be entered in a prize drawing for each completed kit collected from that volunteer. In instances where prizes are to be awarded, at least one prize winner is chosen from the entries for the prize drawing.

### FIELD OF THE INVENTION

The present invention relates generally to a fundraising system and method, and more particularly, to a fundraising system and method in which contributions are collected by volunteers from donors.

### BACKGROUND OF THE INVENTION

There are many methods for raising funds by charitable and other non-profit organizations. A common method is the solicitation of direct monetary donations by members of the organization and by non-members who support the goals and programs of such organizations. However, there are numerous disadvantages of such a method. One disadvantage of this method is that many potential donors who would otherwise be willing to make direct donations to the organization are unable to do so because of limitations in their finances or more pressing financial obligations. Moreover, even if potential donors are able to afford a contribution, they may not be charitably inclined, and may therefore, not desire to contribute large sums. Such potential donors may be embarrassed to contribute a small sum, and may therefore decline to contribute at all. Furthermore, potential donors who would otherwise contribute to the organization may simply not have the cash on hand at the time they are approached for the donation. Another disadvantage of such a method is that those soliciting donations may be reluctant to do so, because they are reluctant to ask potential donors for the relatively large sums of money typically requested.

Another fundraising method which has been developed is the sale of raffle tickets. In this method, donors, in return for their donations, receive the opportunity to win prizes. Thus, donors may be somewhat more willing to make contributions, as they feel they are getting something in return. While this method has some benefits over simply soliciting donations, it still suffers from a number of the same disadvantages. For example, potential donors may still not be able to afford making direct donations to the organization because of limitations in their finances or more pressing financial obligations, and simply may not be able to afford the raffle ticket. Moreover, even if potential donors are able to afford a contribution, they may not be charitably inclined, and may therefore, not desire to contribute the sum charged for the raffle ticket. Furthermore, potential donors who would otherwise contribute to the organization may simply not have the cash on hand at the time they are approached for purchase of the raffle ticket. In addition, those selling raffle tickets may be reluctant to do so, because they are reluctant to ask potential donors for the amount of money charged for the raffle ticket.

Still another fundraising method which has been developed is the solicitation of pledges. In this method, a contributor is requested to make a pledge, and then later to honor the pledge by payment of the amount pledged. While this method may obviate the problem of donors not having the cash on hand at the time of solicitation as described above, this method still suffers from the other disadvantages of the above-described methods. In addition, this method suffers from disadvantages of its own. One such disadvantage is that a number of pledges do not get honored. Some contributors forget about their pledge. Moreover, the contributor's financial situation may have changed between the making of a pledge and the honoring the pledge so that he or she no longer has adequate funds, even though the contributor had adequate funds available at the time a pledge was made. In any event, in such situations fund-raising organizations lose pledged contributions.

What is desired, therefore, is a fundraising system and method which seeks sums of money which substantially all potential donors can afford, which seeks sums of money which substantially all potential donors are comfortable donating, which seeks donations in a form which substantially all potential donors will have on hand when approached for donation, which seeks sums of money which those soliciting donations are comfortable soliciting, and which seeks donations at the time of solicitation.

### SUMMARY OF THE INVENTION

Accordingly, it is an object of the present invention to provide a fundraising system and method which seeks sums of money which substantially all potential donors can afford.

Another object of the present invention is to provide a fundraising system and method having the above characteristics and which seeks sums of money which substantially all potential donors are comfortable donating.

A further object of the present invention is to provide a fundraising system and method having the above characteristics and which seeks donations in a form which substantially all potential donors will have on hand when approached for donation.

Still another object of the present invention is to provide a fundraising system and method having the above characteristics and which seeks sums of money which those soliciting donations are comfortable soliciting.

Yet a further object of the present invention is to provide a fundraising system and method having the above characteristics and which seeks donations at the time of solicitation.

These and other objects of the present invention are achieved by provision of a fundraising method and a kit for use with such a method. The method involves providing volunteers with a fundraising kit having a predetermined capacity for holding coins, and allowing time for the volunteers to collect coins and to at least partially fill the fundraising kits with collected coins. Completed fundraising kits are collected from the volunteers and each volunteer may be entered in a prize drawing for each completed kit collected from that volunteer. All outstanding fundraising kits, whether or not completed, are collected from the volunteers at the end of a predetermined time period and, again, each volunteer may be entered in a prize drawing for each completed kit collected from that volunteer. In the instances where prizes are to be awarded, at least one prize winner is chosen from the entries for the prize drawing.

Preferably, after completed kits are collected additional fundraising kits are provided, if the predetermined time period has not expired, to volunteers from whom completed fundraising kits are collected. Preferably, the fundraising kit includes at least one empty roll of coins, and the predetermined capacity for holding coins is based on the capacity of the at least one roll of coins. Even more preferably, the fundraising kit includes an empty roll for pennies, an empty roll for nickels, an empty roll for dimes and an empty roll for quarters. Most preferably, the capacity of the empty roll for pennies is $0.50, the capacity of the empty roll for nickels is $2.00, the capacity of the empty roll for dimes is $5.00 and the capacity of the empty roll for quarters is $10.00, whereby the capacity of the fundraising kit is $17.50. The fundraising kit may further include a bonus area for receiving funds beyond the capacities of the empty roll for pennies, the empty roll for nickels, the empty roll for dimes and the empty roll for quarters.

In one embodiment, instead of the prize winner simply being chosen and awarded a prize, a potential prize winner is chosen from the entries for the prize drawing. The chosen potential prize winner is notified of at least one condition which must be satisfied before being awarded a prize. It is then determined whether the at least one condition has been satisfied. If the at least one condition has been satisfied, the prize is awarded to the potential prize winner. If the at least one condition has not been satisfied within a predetermined time period, another potential prize winner is chosen from the entries for the prize drawing and the notifying, determining, awarding and choosing steps are repeated.

In another aspect, the present invention is directed to a fundraising kit for facilitating a fundraiser. The fundraising kit includes an empty roll for pennies, an empty roll for nickels, an empty roll for dimes and an empty roll for quarters, each of the empty rolls having a predetermined capacity for holding respective coins. The kit also includes a container having at least four slots therein sized and shaped respectively to fit the roll for pennies, the roll for nickels, the roll for dimes and the roll for quarters when each is filled to the predetermined capacity.

Preferably, the capacity of the empty roll for pennies is $0.50, the capacity of the empty roll for nickels is $2.00, the capacity of the empty roll for dimes is $5.00 and the capacity of the empty roll for quarters is $10.00, whereby the capacity of the fundraising kit is $17.50. If desired, the kit may include a bonus space for receiving funds beyond the capacities of the empty roll for pennies, the empty roll for nickels, the empty roll for dimes and the empty roll for quarters.

The container may be constructed from paper or cardboard originally formed as a flat sheet. Similarly, the empty roll for pennies, the empty roll for nickels, the empty roll for dimes and the empty roll for quarters may be constructed from a single sheet of perforated paper or cardboard with adhesive applied thereto. The container preferably has printed thereon one or more logos related to the fundraiser. It is also preferable that the container has printed thereon in at least one location a unique identifier to facilitate tracking of the fundraising kit. Most preferably, the container comprises at least two sections separable from each other, each of the sections having printed thereon a unique identifier to facilitate tracking of the fundraising kit, such that separation of the two sections from each other destroys the container whereby it cannot be reused. The empty roll for pennies, the empty roll for nickels, the empty roll for dimes and the empty roll for quarters preferably also have printed thereon one or more logos related to the fundraiser.

The invention and its particular features and advantages will become more apparent from the following detailed description considered with reference to the accompanying drawings.

### BRIEF DESCRIPTION OF THE DRAWINGS

FIG. 1 is a flow chart illustrating a fundraising method in accordance with one embodiment of the present invention;

FIG. 2 is a flow chart illustrating in more detail one particular embodiment of a portion of the fundraising method of FIG. 1;

FIG. 3 is an isometric view of portions of a fundraising kit used in conjunction with the fundraising method of FIG. 1;

FIGS. 4A-4D are isometric views of additional portions of the fundraising kit shown in FIG. 3; and

FIG. 5 is a plan view of the portions of the fundraising kit shown in FIGS. 4A-4D shown in an unassembled condition.

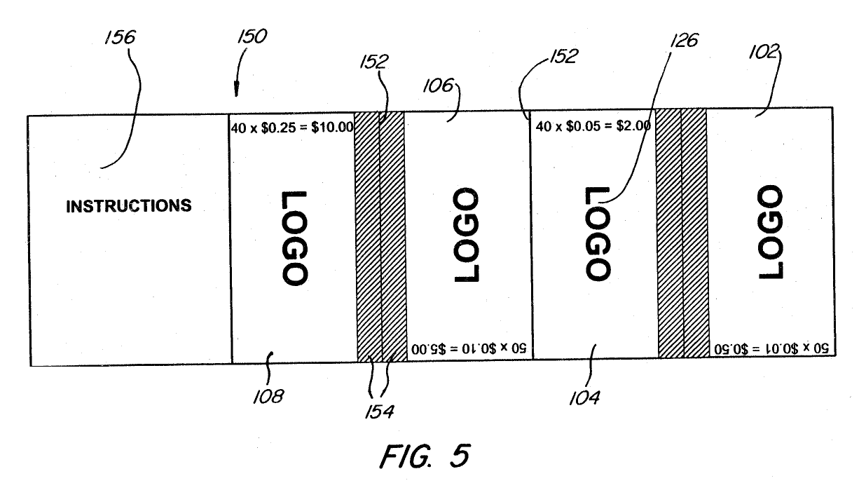

### DETAILED DESCRIPTION OF AN EMBODIMENT OF THE INVENTION

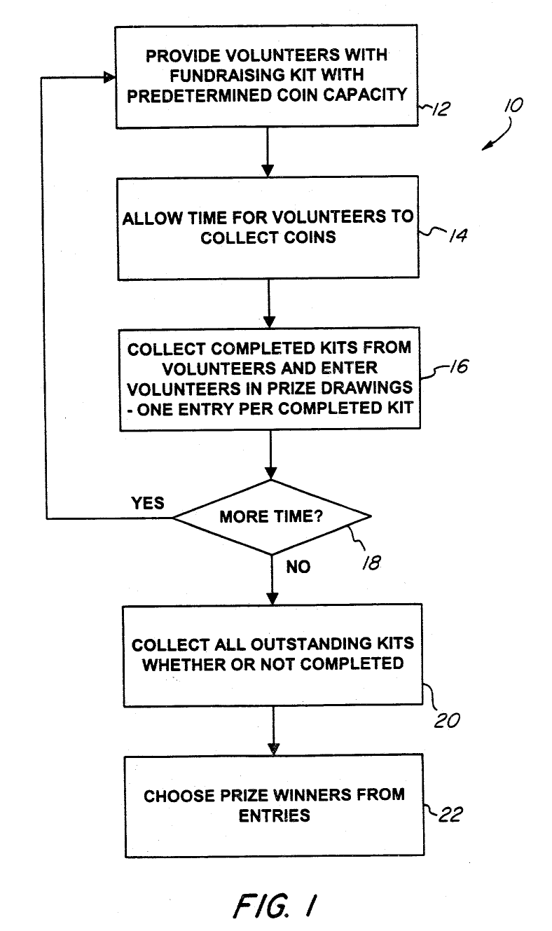

Referring first to FIG. 1 a fundraising method 10 in accordance with the present invention is shown. Substantially everyone has loose change lying about—it can be found in pockets, in bottles, in forgotten piggy banks, in the kitchen drawer at home, in desk drawers at work, and numerous other places. Fundraising method 10 takes advantage of this fact by providing a novel method of collecting this loose change for fundraising purposes, thereby benefiting the charity or institution hosting the fundraiser, while at the same time allowing donors to feel good about helping a worthy cause by sacrificing only loose change, which the donor likely had no plans for spending anyway.

Volunteers are each provided with a fundraising kit, as illustrated at step 12. Each of the fundraising kits has a predetermined capacity for holding coins. For example the fundraising kit may have a capacity of $0.50 in pennies, $2.00 in nickels, $5.00 in dimes and $10.00 in quarters, whereby the capacity of the fundraising kit is $17.50. It may be recognized that the above capacities correspond to the capacities of traditional rolls of U.S. coins. Of course, other predetermined capacities are also possible. For example, it may be desirable, for example, to collect only one particular denomination of coin (e.g., quarters or dimes only). Moreover, it should be noted that the denominations and quantity of coins which comprise the predetermined capacity may also be dependent upon the country in which coin collection is to occur, in which countries various denominations other than the standard U.S. denominations of pennies, nickels, dimes and quarters may be employed.

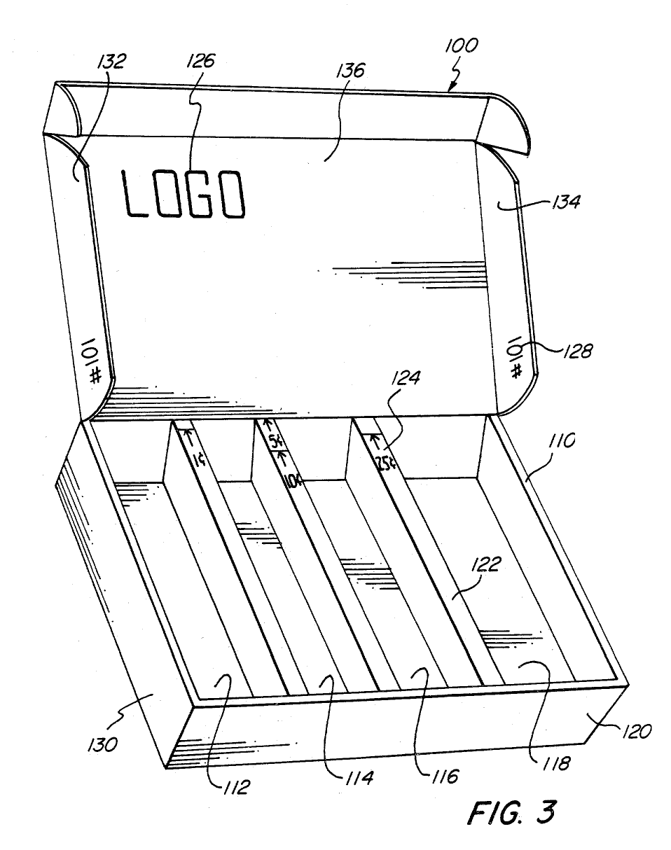

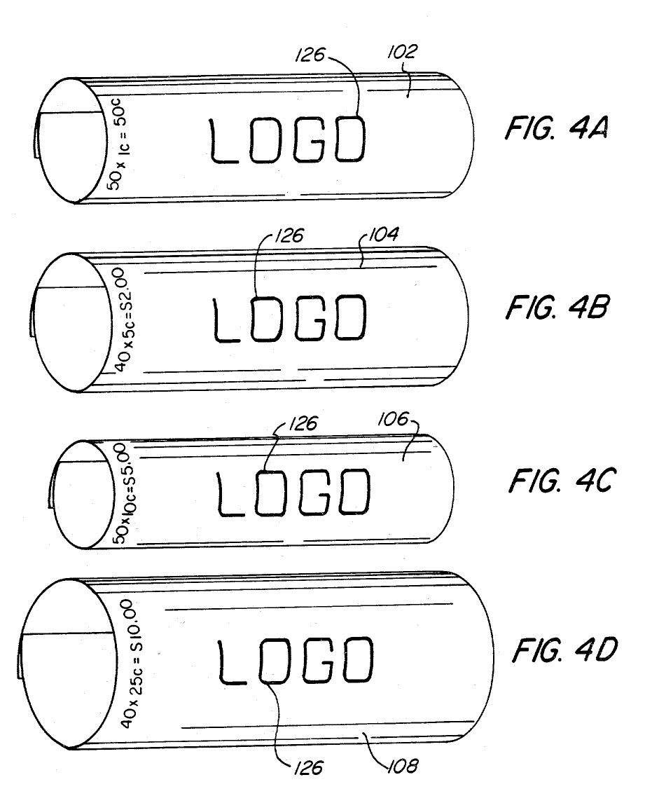

In order to facilitate collection and redemption of the coins, the fundraising kit may also include an empty roll for pennies, an empty roll for nickels, an empty roll for dimes and an empty roll for quarters. The fundraising kit may further include a bonus area for receiving funds beyond the capacities of the empty roll for pennies, the empty roll for nickels, the empty roll for dimes and the empty roll for quarters. One embodiment of a fundraising kit which may be used with fundraising method 10 is discussed in more detail below with reference to FIGS. 3 and 4.

As the term “volunteers” implies, it is preferable that no one be obligated to take a fundraising kit. However, as should be obvious, anyone not participating in the fundraising effort will not be eligible for any prizes. Moreover, all volunteers should only agree to take responsibility for a fundraising kit if they are prepared to do the fundraising. Directions should also be provided to the volunteers as to how to approach potential donors in order to solicit contributions, particularly when the volunteers involved are young children.

After the volunteers are provided with fundraising kits, they are allowed time to collect coins, as shown at step 14. The time period allowed for collecting contributions may vary, but should be on the order of at least several weeks. Four weeks, for example, should provide ample time for collecting contributions. Volunteers may ask their parents, grandparents, other relatives, friends, neighbors, etc., for loose change in order to help them complete their fundraising kits. Because the amount of money being sought is very small, substantially all potential donors can afford to contribute. Moreover, donors are likely to feel comfortable about contributing larger sums of money, because the money being donated is merely loose change. For example, a donor may feel comfortable about contributing $10.00 in loose change which has been sitting in a drawer for years, but not feel comfortable donating a $10.00 bill from his/her wallet or purse. Moreover, the form of the donation sought (i.e., loose change) makes likely that donors will have the donation on hand when approached for donation. Furthermore, because only loose change is being sought, volunteers are likely to be more comfortable soliciting donations, rather than if larger sums were being sought.

Fundraising kits may be returned to the person or entity running the fundraiser when they are completed (i.e., full), and the volunteer returning the kit may be entered in a prize drawing—one entry for each completed kit returned (shown in step 16). It should be noted that each volunteer is preferably only allowed to have one fundraising kit at a time, in order to facilitate tracking of the kits and reduce the likelihood of kits being lost and/or misused. However, after returning completed kits, and if more time is left in the fundraiser (as indicated at step 18), volunteers returning completed kits may be provided with another kit, and steps 12, 14 and 16 may be repeated until no more time is available. The benefit to the volunteers of completing multiple kits is that they are entered in the prize drawing for each completed kit returned. Thus, with each completed kit returned, the chance of winning a prize increases dramatically. Of course, if the volunteer returning the completed kit does not want to collect more donations, he or she may decline another fundraising kit.

After expiration of the time allotted for the fundraiser, all outstanding kits, whether or not completed, are collected (shown at step 20). Volunteers returning completed fundraising kits at this step are also entered in the prize drawing. However, volunteers who return kits which have not been completed are not entered in the prize drawing. If desired, however, a second prize drawing, generally involving smaller prizes, may be conducted for volunteers returning only partially completed kits. Of course, if the volunteer has previously returned a completed kit at step 16, he or she has already been entered at least once in the prize drawing.

When all outstanding kits have been collected, prize winners are chosen from the entries for completed kits (shown at step 22). The prizes awarded can range in value from very small nominal gifts to big-ticket items, such as electronic equipment and automobiles. Typically, 25-40% of the funds collected may go to prizes, with the balance going to the organization conducting the fundraiser, although this is only a general guideline. As should be obvious to those skilled in the art, however, the higher the percentage of funds that is allocated to prizes and to marketing, the more the excitement that can be generated, and the more money that can be raised.

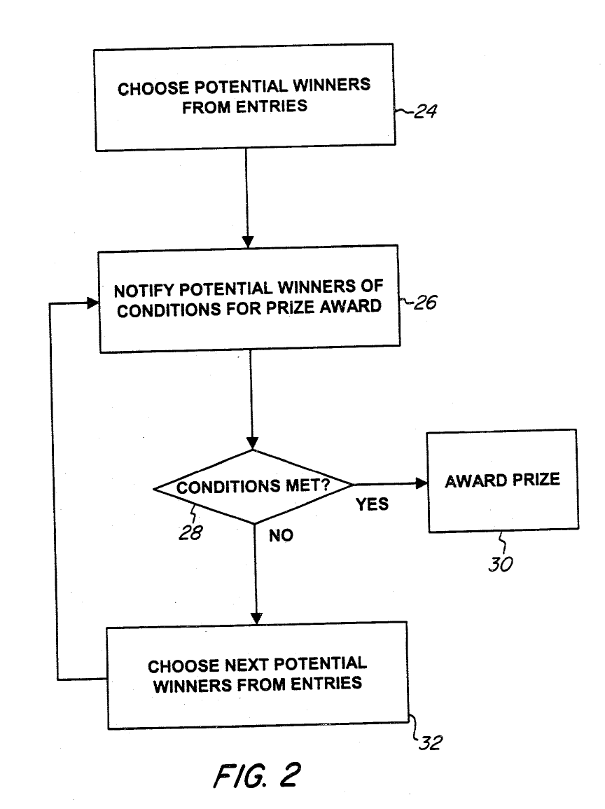

Referring now to FIG. 2, in one preferred embodiment of the invention, instead of the prize winner simply being chosen and awarded a prize, a potential prize winner is chosen from the entries for the prize drawing (shown at step 24). At step 26, the chosen potential prize winner is notified of at least one condition which must be satisfied before being awarded a prize. It is then determined at step 28 whether the at least one condition has been satisfied. If the at least one condition has been satisfied, the prize is awarded to the potential prize winner at 30. If the at least one condition has not been satisfied within a predetermined time period, another potential prize winner is chosen from the entries for the prize drawing (shown at step 32) and the notifying, determining, awarding and choosing steps are repeated. For example, suppose that one of the prizes is an automobile. The winner would not immediately win the automobile, but would win the opportunity to win the automobile. This opportunity, for example, could be contingent upon the potential winner passing two drivers' education classes with distinction, upon obtaining good behavior testimonials from two or more teachers, upon having grades to keep the potential winner on the honor roll, or upon similar achievement goals. If the potential winner does not satisfy the contingency, the “opportunity” to win the automobile goes to the next eligible potential winner.

Preferably, all kits are tracked by, for example, kit number, volunteer name, etc. Every time a kit is given to or returned by a volunteer, a list is maintained to reflect such. For kits which are not returned, whether having been lost, stolen, etc. various steps may be taken. For example, in an effort to teach a lesson in responsibility (particularly when the volunteers are youths), the volunteer not returning a kit may be required to pay all, or a portion, of the capacity of the kit. Alternatively, or in addition to this, volunteers not returning a kit may be precluded from participating in future fundraising events and thus not be eligible for the prizes connected therewith. Many other remedial measures are also possible.

The present inventive method allows for the collection of large amounts of funds with little effort on the part of the organizer of the fundraiser and on the part of the volunteers soliciting funds. For example, suppose there are 3,000 high school students in a typical small town. If only 50% of these students get involved, and each raises $17.50, this will total $26,250. Subtracting 40% ($10,500) for prizes yields $15,750 raised. However, many students, perhaps 20% of those participating in the fundraiser, will fill two or more kits. One additional kit filled by another 20% of participating students yields another $5,250. Thus, in this example, $21,000 can be easily raised in a short period of time (four weeks, for example) with very little effort on the part of students or faculty. Even more money could be raised in schools with larger student populations with only little more effort.

Although the inventive fundraising method of the present invention is particularly well-suited for fundraisers involving children volunteers, such as for schools, clubs, youth organizations, sports teams, and the like, adult organizations, such as church groups, professional fundraising companies, and substantially any charitable organization, may also employ the inventive fundraising method of the present invention.

Referring now to FIGS. 3 and 4A-4D, a fundraising kit 100 for use with fundraising method 10 is illustrated. The fundraising kit includes an empty roll for pennies 102, an empty roll for nickels 104, an empty roll for dimes 106 and an empty roll for quarters 108, each of the empty rolls having a predetermined capacity for holding respective coins. Kit 100 also includes a container 110 or the like having at least four slots therein sized and shaped respectively to fit the roll for pennies 112, the roll for nickels 114, the roll for dimes 116 and the roll for quarters 118 when each is filled to the predetermined capacity. Container 110 may be formed from any of a number of materials, although a paper or cardboard material has proven to work well and allows container 110 to be distributed in a generally flat configuration for assembly by the volunteer. In this case, container 110 may comprise a box 120 and a divider card 122, which together define slots 112,114, 116,118.

Preferably, the capacity of the empty roll for pennies 102 is $0.50, the capacity of the empty roll for nickels 104 is $2.00, the capacity of the empty roll for dimes 106 is $5.00 and the capacity of the empty roll for quarters 108 is $10.00, whereby the capacity of fundraising kit 100 is $17.50. Kit 100 may also include a bonus space for receiving funds beyond the capacities of the empty coin rolls 102, 104,106, 108, although such is not required. When such is the case, the capacity of bonus space may be $2.50, whereby the capacity of fundraising kit 100 is an even $20.00. Preferably, container 110 includes coin-count markings 124 by which one can easily verify that coin rolls 102, 104,106, 108 are properly filled.

Fundraising kit 100 may also include information about the fundraiser printed on the inside of a lid of container 110, for example. This information may include, for example, directions to the volunteers concerning the fundraiser, information regarding the entity conducting the fundraiser, or other like information. Container 110 may also have printed thereon a decorative design and/or one or more logos 126 related to the fundraiser, such as a logo for the entity conducting the fundraiser and/or the logo of a sponsor of the fundraiser, such as an entity donating prizes or the like.

Also printed on container 110 is a unique identifier 128 to facilitate tracking of fundraising kit 100, as described more fully above. Unique identifier 128 may comprise, for example, a number (in which case kits 100 may be sequentially numbered), the name of the volunteer to whom kit 100 have been given, or both. Preferably, container 110 comprises three sections with unique identifier 128 printed on each of the three sections, which sections are separable from each other in order to further facilitate tracking of kits 100, and to facilitate the drawing of prizes. When completed kits are returned, one section with unique identifier 128 printed thereon is detached and given to the volunteer returning the completed kit as a kit receipt, one section with unique identifier 128 printed thereon is retained by the organization conducting the fundraiser, and one section with unique identifier 128 printed thereon is disposed within a prize drawing barrel, drum or the like, so that prize winners and/or potential prize winners may be drawn, as more fully described above. Most preferably, the three sections with unique identifier 128 printed thereon are configured so as to require that container 110 be destroyed when the sections are separated so as to prevent container 110 from being reused. For example, the three sections with unique identifier 128 printed thereon may comprise a container body 130, and flaps 132, 134 of a container cover 136.

The empty roll for pennies 102, the empty roll for nickels 104, the empty roll for dimes 106 and the empty roll for quarters 108 preferably may also have printed thereon a decorative design and/or one or more logos 126 as described above in connection with container 110. If desired, coin rolls 102,104,106,108 may be provided to volunteer in a flat, unassembled condition, such that the volunteer may be required to assemble coin rolls 102,104,106,108. For example, coin rolls 102,104, 106,108 may be provided as a single flat sheet 150 of paper or cardboard with appropriately placed perforations 152 and pressure sensitive or moisture-activated adhesive 154, and instructions 156 as to how to assemble coin rolls 102, 104, 106, 108.

Fundraising kit 100 may include many additional features to aid in the collection of donations. For example, fundraising kit 100 may include a mail-back box into which filled containers 110 may be inserted in order to facilitate mailing of containers 110 back to those responsible for collecting completed containers 110. Fundraising kit 100 may also include various coupons, inserts, etc.

The present invention, therefore, provides a fundraising system and method which seeks sums of money which substantially all potential donors can afford, which seeks sums of money which substantially all potential donors are comfortable donating, which seeks donations in a form which substantially all potential donors will have on hand when approached for donation, which seeks sums of money which those soliciting donations are comfortable soliciting, and which seeks donations at the time of solicitation.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A fundraising method comprising the steps of:
providing volunteers with a fundraising kit having a predetermined capacity for holding coins;
allowing time for the volunteers to collect coins and to at least partially fill the fundraising kits with collected coins;
collecting completed fundraising kits from the volunteers and entering each volunteer in a prize drawing for each completed kit collected from that volunteer;
collecting all outstanding fundraising kits, whether or not completed, from the volunteers at the end of a predetermined time period and entering each volunteer in a prize drawing for each completed kit collected from that volunteer; and
choosing at least one prize winner from the entries for the prize drawing.

2. The fundraising method of claim 1 further comprising the step of, after said collecting completed kits step, providing an additional fundraising kit, if the predetermined time period has not expired, to volunteers from whom completed fundraising kits are collected.

3. The fundraising method of claim 1 wherein said fundraising kit includes at least one empty roll of coins, and wherein the predetermined capacity for holding coins is based on the capacity of the at least one roll of coins.

4. The fundraising method of claim 3 wherein the fundraising kit includes an empty roll for pennies, an empty roll for nickels, an empty roll for dimes and an empty roll for quarters.

5. The fundraising method of claim 4 wherein the capacity of the empty roll for pennies is $0.50, wherein the capacity of the empty roll for nickels is $2.00, wherein the capacity of the empty roll for dimes is $5.00 and wherein the capacity of the empty roll for quarters is $10.00, whereby the capacity of the fundraising kit is $17.50.

6. The fundraising method of claim 4 wherein the fundraising kit further includes a bonus space for receiving funds beyond the capacities of the empty roll for pennies, the empty roll for nickels, the empty roll for dimes and the empty roll for quarters.

7. The fundraising method of claim 1 wherein said choosing at least one prize winner step comprises the steps of:
choosing a potential prize winner from the entries for the prize drawing;
notifying the chosen potential prize winner of at least one condition which must be satisfied before being awarded a prize;
determining whether the at least one condition has been satisfied; and
awarding the prize to the potential prize winner if the at least one condition has been satisfied.

8. The fundraising method of claim 7 wherein said choosing at least one prize winner step further comprises the step of choosing another potential prize winner from the entries for the prize drawing and repeating said notifying, said determining, said awarding and said choosing steps if the at least one condition has not been satisfied within a predetermined time period.

9. A fundraising method comprising the steps of:
providing volunteers with a fundraising kit having a predetermined capacity for holding coins, wherein said fundraising kit includes at least one empty roll of coins, and wherein the predetermined capacity for holding coins is based on the capacity of the at least one roll of coins;
allowing time for the volunteers to collect coins and to at least partially fill the fundraising kits with collected coins;
collecting completed fundraising kits from the volunteers and entering each volunteer in a prize drawing for each completed kit collected from that volunteer;
collecting all outstanding fundraising kits, whether or not completed, from the volunteers at the end of a predetermined time period and entering each volunteer in a prize drawing for each completed kit collected from that volunteer; and
choosing a potential prize winner from the entries for the prize drawing;
notifying the chosen potential prize winner of at least one condition which must be satisfied before being awarded a prize;
determining whether the at least one condition has been satisfied;
awarding the prize to the potential prize winner if the at least one condition has been satisfied; and
choosing another potential prize winner from the entries for the prize drawing and repeating said notifying, said determining, said awarding and said choosing steps if the at least one condition has not been satisfied within a predetermined time period.

10. The fundraising method of claim 9 further comprising the step of, after said collecting completed kits step, providing an additional fundraising kit, if the predetermined time period has not expired, to volunteers from whom completed fundraising kits are collected.

11. The fundraising method of claim 9 wherein the fundraising kit includes an empty roll for pennies, an empty roll for nickels, an empty roll for dimes and an empty roll for quarters.

12. The fundraising method of claim 11 wherein the capacity of the empty roll for pennies is $0.50, wherein the capacity of the empty roll for nickels is $2.00, wherein the capacity of the empty roll for dimes is $5.00 and wherein the capacity of the empty roll for quarters is $10.00, whereby the capacity of the fundraising kit is $17.50.

13. The fundraising method of claim 11 wherein the fundraising kit further includes a bonus space for receiving funds beyond the capacities of the empty roll for pennies, the empty roll for nickels, the empty roll for dimes and the empty roll for quarters.

14. A fundraising kit for facilitating a fundraiser, said fundraising kit comprising:
an empty roll for pennies, an empty roll for nickels, an empty roll for dimes and an empty roll for quarters, each of said empty rolls having a predetermined capacity for holding respective coins; and
a container having at least four slots therein sized and shaped respectively to fit the roll for pennies, the roll for nickels, the roll for dimes and the roll for quarters when each is filled to the predetermined capacity.

15. The fundraising kit of claim 14 wherein the capacity of the empty roll for pennies is $0.50, wherein the capacity of the empty roll for nickels is $2.00, wherein the capacity of the empty roll for dimes is $5.00 and wherein the capacity of the empty roll for quarters is $10.00, whereby the capacity of the fundraising kit is $17.50.

16. The fundraising kit of claim 14 further comprising a bonus space for receiving funds beyond the capacities of the empty roll for pennies, the empty roll for nickels, the empty roll for dimes and the empty roll for quarters.

17. The fundraising kit of claim 14 wherein said container is constructed from paper or cardboard originally formed as a flat sheet.

18. The fundraising kit of claim 14 wherein said empty roll for pennies, said empty roll for nickels, said empty roll for dimes and said empty roll for quarters are constructed from a single sheet of perforated paper or cardboard with adhesive applied thereto.

19. The fundraising kit of claim 14 wherein said container has printed thereon one or more logos related to the fundraiser.

20. The fundraising kit of claim 14 wherein said container has printed thereon in at least one location a unique identifier to facilitate tracking of said fundraising kit.

21. The fundraising kit of claim 20 wherein said container comprises at least two sections separable from each other, each of the sections having printed thereon a unique identifier to facilitate tracking of said fundraising kit, wherein separation of the two sections from each other destroys said container whereby it cannot be reused.

22. The fundraising kit of claim 14 wherein the empty roll for pennies, the empty roll for nickels, the empty roll for dimes and the empty roll for quarters have printed thereon one or more logos related to the fundraiser.

23. A fundraising kit for facilitating a fundraiser, said fundraising kit comprising:
an empty roll for pennies, an empty roll for nickels, an empty roll for dimes and an empty roll for quarters, each of said empty rolls having a predetermined capacity for holding respective coins, each of said empty rolls having printed thereon one or more logos related to the fundraiser, wherein said empty roll for pennies, said empty roll for nickels, said empty roll for dimes and said empty roll for quarters are constructed from a single sheet of perforated paper or cardboard with adhesive applied thereto;
a container having at least four slots therein sized and shaped respectively to fit the roll for pennies, the roll for nickels, the roll for dimes and the roll for quarters when each is filled to the predetermined capacity, and a bonus space for receiving funds beyond the capacities of the empty roll for pennies, the empty roll for nickels, the empty roll for dimes and the empty roll for quarters, wherein said container is constructed from paper or cardboard originally formed as a flat sheet.

24. The fundraising kit of claim 23 wherein the capacity of the empty roll for pennies is $0.50, wherein the capacity of the empty roll for nickels is $2.00, wherein the capacity of the empty roll for dimes is $5.00 and wherein the capacity of the empty roll for quarters is $10.00, whereby the capacity of the fundraising kit is at least $17.50.

25. The fundraising kit of claim 23 wherein said container has printed thereon one or more logos related to the fundraiser.

26. The fundraising kit of claim 23 wherein said container has printed thereon in at least one location a unique identifier to facilitate tracking of said fundraising kit.

27. The fundraising kit of claim 26 wherein said container comprises at least two sections separable from each other, each of the sections having printed thereon a unique identifier to facilitate tracking of said fundraising kit, wherein separation of the two sections from each other destroys said container whereby it cannot be reused.

28. A fundraising method comprising the steps of:
providing volunteers with a fundraising kit having a predetermined capacity for holding coins;
allowing time for the volunteers to collect coins and to at least partially fill the fundraising kits with collected coins;
collecting completed fundraising kits from the volunteers; and
collecting all outstanding fundraising kits, whether or not completed, from the volunteers at the end of a predetermined time period.

29. The fundraising method of claim 28 further comprising the step of, after said collecting completed kits step, providing an additional fundraising kit, if the predetermined time period has not expired, to volunteers from whom completed fundraising kits are collected.

30. The fundraising method of claim 28 wherein said fundraising kit includes at least one empty roll of coins, and wherein the predetermined capacity for holding coins is based on the capacity of the at least one roll of coins.

31. The fundraising method of claim 30 wherein the fundraising kit includes an empty roll for pennies, an empty roll for nickels, an empty roll for dimes and an empty roll for quarters.

32. The fundraising method of claim 31 wherein the capacity of the empty roll for pennies is $0.50, wherein the capacity of the empty roll for nickels is $2.00, wherein the capacity of the empty roll for dimes is $5.00 and wherein the capacity of the empty roll for quarters is $10.00, whereby the capacity of the fundraising kit is $17.50.

33. The fundraising method of claim 31 wherein the fundraising kit further includes a bonus space for receiving funds beyond the capacities of the empty roll for pennies, the empty roll for nickels, the empty roll for dimes and the empty roll for quarters.
